(19) United States
(12) Patent Application Publication
(10) Pub. No.: US 2025/0151015 A1
(43) Pub. Date: May 8, 2025

(54) METHODS, APPARATUSES, AND COMPUTER PROGRAM PRODUCTS FOR VALID REPORTING OF TIMING MEASUREMENTS FOR NEW RADIO CARRIER PHASE POSITIONING

(71) Applicant: Nokia Technologies Oy, Espoo (FI)

(72) Inventors: Abdurrahman FOUDA, Naperville, IL (US); Hyun-Su CHA, Naperville, IL (US)

(21) Appl. No.: 18/933,812

(22) Filed: Oct. 31, 2024

Related U.S. Application Data
(60) Provisional application No. 63/596,128, filed on Nov. 3, 2023.

(51) Int. Cl. H04W 64/00; G01S 13/76

(52) U.S. Cl. CPC H04W 64/00; G01S 13/765

(57) ABSTRACT

A method, apparatus and computer program product are provided for aligning the reporting of timing measurements and corresponding carrier phase (CP) measurements to avoid CP measurement error due to stale timing measurement information. In the context of a method, the method includes receiving, at a user equipment (UE), a request to maintain time separation between respective timestamps of carrier phase (CP) measurements and timing measurements within a predefined timing separation threshold. The method further includes generating, at the UE, at least one DL CP measurement associated with at least one timestamp, and at least one DL timing measurement associated with at least one DL timing measurement timestamp based on the predefined timing separation threshold, wherein a timing separation between the at least one timestamp and the at least one DL timing measurement timestamp is within the predefined timing separation threshold.

### RELATED APPLICATION

This application claims priority to U.S. provisional Application No. 63/596,128 filed Nov. 3, 2023, which is incorporated herein by reference in its entirety.

### TECHNICAL FIELD

An example embodiment relates generally to new signaling techniques for aligning the reporting of timing measurements and corresponding carrier phase (CP) measurements to avoid CP measurement error due to stale timing measurement information.

### BACKGROUND

In legacy approaches to carrier phase positioning (CPP), large time separation between the timestamps of the time and CP measurement (e.g., due to different reporting granularity or different number of sample/instances per measurement report) may result in stale time information at the UE and substantially degrade the positioning estimation accuracy of the CPP techniques. The misalignment between time and corresponding CP measurements due to large time separation may result in ambiguous phase measurements. For example, the misalignment of time and CP measurements may increase the difficulty of, or make impossible, estimating the number of complete phase cycles that a reference signal has travelled between a transmission reception point and a UE to produce the same observed phase measurement at the UE. The misalignment and resulting inability to resolve the integer ambiguity for phase cycles may significantly reduce the accuracy or cause total failure of the CPP process.

### BRIEF SUMMARY

A method, apparatus and computer program product are provided in accordance with an example embodiment in order to align the reporting of timing measurements and corresponding carrier phase (CP) measurements. In various embodiments, the present method, apparatus, and computer program product provide improved solutions for aligning the reporting of timing measurements and corresponding carrier phase (CP) measurements together to avoid CP measurement error due to stale timing measurement information at a user equipment (UE). Some embodiments involve configuring new behavior and signaling at an apparatus (e.g., a target UE), a positioning resource unit (PRU), a network element (e.g., location management function (LMF)), and serving/neighbor network nodes (e.g., base stations) to align timing measurement and CP measurement reporting. In some embodiments, the network node has one or multiple transmission and reception points (TRPs) connected to it to facilitate receiving and transmitting signals to and from the network node based on a control by the network node. In some embodiments, the signaling techniques described herein constrain the reporting and/or use of CP and timing data to CP measurements and timing measurements for which a timing separation between the corresponding timestamps falls within a predefined time separation threshold. In some embodiments, the predefined time separation threshold ensures that a maximum time separation between the timestamps of the reported time and CP measurements is within a certain value to align the reporting of corresponding time and CP measurements.

Various embodiments of the described methods, apparatuses, and computer program products introduce and perform techniques to limit the time separation between the reported CP measurements and their corresponding timing measurements within a specific limit. By doing so, the methods, apparatuses, and computer program products may improve CPP estimation accuracy by avoiding CP measurement errors that may occur due to incorrect resolution and integer ambiguity. In some embodiments, the present techniques reconfigure a UE, serving/neighbor nodes, a network element (e.g., LMF), and/or the like with new behavior and signaling. In some embodiments, the signaling techniques are implemented for three operation modes of CPP including downlink CPP (DL CPP) UE-based mode, DL CPP UE-assisted mode, and uplink CPP (UL CPP) mode. In some embodiments, the methods, apparatuses, and computer program products limit the time separation (e.g., distance) between the timestamps of CP positioning measurements and their corresponding timing measurements within a time separation threshold, which may be predefined and/or configured by the network element. In some embodiments, the methods, apparatuses, and computer program products ensure using a valid timestamp of the timing measurements associated with the CP measurements such that the search space for the integer ambiguity may be reduced to successfully resolve integer ambiguity problems for the CP measurements. For example, the methods, apparatuses, and computer program products may ensure that a CPP process uses a timing measurement that for which a corresponding timestamp is within a threshold timing separation of a timestamp for the corresponding CP measurement.

In some embodiments, misalignment between timing measurements and corresponding CP measurements may result in failure to resolve an integer ambiguity issue in CPP. In some embodiments, the integer ambiguity issue refers to resolving the number of unknown complete phase cycles that the reference signal has travelled between the transmission reception point (TRP) and the UE to produce the same observed phase measurement at the UE. The phase measurements (e.g., measures of signal amplitude) may be ambiguous due to periodicity of the signal. In some embodiments, estimation of the phase cycle count using timing measurements and corresponding CP measurements may be challenging due to the phase repeating itself every complete cycle (e.g., 27). In some embodiments, by ensuring that the time separation between the timestamps of the timing measurements and the corresponding CP measurements is within a certain predefined/configured threshold, the entity calculating the UE location can accurately estimate the unknown number of complete phase cycles the reference signal has travelled, which may resolve the integer ambiguity problem and achieve CPP estimation accuracy.

In at least one embodiment, a method is provided that includes receiving, at a user equipment (UE), a request to maintain time separation between respective timestamps of carrier phase (CP) measurements and timing measurements within a predefined timing separation threshold; and generating, at the UE, at least one DL CP measurement associated with at least one timestamp, and at least one DL timing measurement associated with at least one DL timing measurement timestamp based on the predefined timing separation threshold, wherein a timing separation between the at least one timestamp and the at least one DL timing measurement timestamp is within the predefined timing separation threshold. In some embodiments, the method includes, receiving, at the UE, at least one positioning resource unit (PRU) CP measurement, at least one PRU CP timestamp for the at least one PRU CP measurement, and an instruction from a network element. In some embodiments, the instruction instructs the UE to generate an estimated location of the UE using the at least one DL CP measurement, the at least one DL timing measurement, and one of the at least one PRU CP measurement. In some embodiments, a timing separation between a timestamp of the PRU CP measurement and the at least one DL timing measurement timestamp of is within the predefined timing separation threshold. In some embodiments, the method includes generating the estimated location of the UE based on the at least one DL CP measurement, the at least one DL timing measurement and one of the at least one PRU CP measurement, wherein a timing separation between the at least one timestamp and the at least one DL timing measurement timestamp of the is within the predefined timing separation threshold.

In some embodiments, the method includes receiving, at the UE, a request to report CP measurements, timing measurements, and respective timestamps that satisfy the predefined timing separation threshold; and in response to the request, causing provision of the at least one DL CP measurement, the at least one timestamp, the at least one DL timing measurement, and the at least one DL timing measurement timestamp from the UE to the receiver. In some embodiments, the method includes receiving, at the UE, downlink (DL) positioning reference signal (PRS) resources from a network node, wherein: the UE generates the at least one DL CP measurement, the at least one timestamp, the at least one DL timing measurement, and the at least one DL timing measurement timestamp based on the DL PRS resources. In some embodiments, the network node embodies a gNodeB. In some embodiments, the method includes causing provision of the at least one DL CP measurement, the at least one timestamp, the at least one DL timing measurement and, the at least one DL timing measurement timestamp from the UE to a network element to enable the network element to generate an estimated location of the UE based on: the at least one DL CP measurement; the at least one DL timing measurement; and at least one positioning reference unit (PRU) CP measurement and at least one PRU timing measurement received by the network element from a PRU, wherein: a timing separation between the at least one DL timing measurement timestamp and a respective timestamp of the at least one PRU CP measurement satisfy the predefined timing separation threshold; and a timing separation between the at least one timestamp and the at least one DL timing measurement timestamp satisfies the predefined timing separation threshold.

In some embodiments, the predefined timing separation threshold is based on a mobility profile of the UE. In some embodiments, the mobility profile comprises a velocity of the UE. In some embodiments, the method includes receiving an updated timing separation threshold in response to a change to a mobility profile of the UE, wherein the change to the mobility profile is based on a change in the velocity of the UE. In some embodiments, the network element embodies a location management function (LMF) and any of the request to maintain time separation, request to report CP measurements, timing measurements, and the respective timestamps, or the updated timing separation threshold are received from the LMF.

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to receive a request to maintain time separation between respective timestamps of carrier phase (CP) measurements and timing measurements within a predefined timing separation threshold; and generate at least one downlink (DL) CP measurement associated with at least one timestamp and at least one DL timing measurement associated with at least one DL timing measurement timestamp based on the predefined timing separation threshold, wherein a respective timing separation between the at least one timestamp and the at least one DL timing measurement timestamp is within the predefined timing separation threshold. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to receive, at a user equipment (UE), a request to maintain time separation between respective timestamps of carrier phase (CP) measurements and timing measurements within a predefined timing separation threshold; and generate at least one DL CP measurement, at least one DL CP timestamp, at least one DL timing measurement, and at least one DL timing measurement timestamp based on the predefined timing separation threshold, wherein a timing separation between the at least one timestamp and the at least one DL timing measurement timestamp is within the predefined timing separation threshold. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for receiving a request to maintain time separation between respective timestamps of carrier phase (CP) measurements and timing measurements within a predefined timing separation threshold; and means for generating at least one DL CP measurement associated with at least one timestamp, and at least one DL timing measurement associated with at least one DL timing measurement timestamp based on the predefined timing separation threshold, wherein a timing separation between the at least one timestamp and the at least one DL timing measurement timestamp is within the predefined timing separation threshold. In the same example, the apparatus may embody additional aspects and/or include additional means for performing additional operations of the above-described methods.

In at least one embodiment, a method is provided that includes receiving, at a network node, a request from a network element to maintain the time separation between respective timestamps of at least one carrier phase (CP) measurement and at least one UL timing measurement within a predefined timing separation threshold; and causing provision of a report from network node to the network element, wherein the report comprises at least one UL CP measurement, at least one UL timing measurement, and the respective timestamps for the at least one UL CP measurement and the at least one UL timing measurement that satisfy the predefined timing separation threshold to cause the network element to generate an estimated location of a user equipment (UE) based on the at least one UL CP measurement and the at least one timing UL measurement.

In some embodiments, the at least one UL CP measurement, the at least one UL timing measurement, and the respective timestamps are obtained using received uplink sounding reference signals (UL SRS) from the UE and a positioning reference unit (PRU). In some embodiments, the method includes causing provision of a UE mobility profile associated with the UE, by the network node, to a network element to cause the network element to generate the predefined timing separation threshold between the timestamps of the UL CP and timing measurements based on the UE mobility profile. In some embodiments, the network node generates the at least one UL CP measurement, the at least one UL timing measurement, and the respective timestamps for the at least one UL CP measurement and the at least one UL timing measurement that satisfy the predefined timing separation threshold. In some embodiments, the network element embodies a location management function (LMF). In some embodiments, the network node embodies a gNodeB.

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to receive a request from a network element to maintain the time separation between respective timestamps of at least one carrier phase (CP) measurement and at least one UL timing measurement within a predefined timing separation threshold; and cause provision of a report from network node to the network element, wherein the report comprises at least one UL CP measurement, at least one UL timing measurement, and the respective timestamps for the at least one UL CP measurement and the at least one UL timing measurement that satisfy the predefined timing separation threshold to cause the network element to generate an estimated location of a user equipment (UE) based on the at least one UL CP measurement and the at least one UL timing measurement. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to receive, at a network node, a request from a network element to maintain the time separation between respective timestamps of at least one carrier phase (CP) measurement and at least one UL timing measurement within a predefined timing separation threshold; and cause provision of a report from network node to the network element, wherein the report comprises at least one UL CP measurement, at least one UL timing measurement, and the respective timestamps for the at least one UL CP measurement and the at least one UL timing measurement that satisfy the predefined timing separation threshold to cause the network element to generate an estimated location of a user equipment (UE) based on the at least one UL CP measurement and the at least one UL timing measurement. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for receiving a request to maintain the time separation between respective timestamps of at least one carrier phase (CP) measurement and at least one UL timing measurement within a predefined timing separation threshold; and means for causing provision of a report from the apparatus to a network element, wherein the report comprises at least one UL CP measurement, at least one UL timing measurement, and the respective timestamps for the at least one UL CP measurement and the at least one UL timing measurement that satisfy the predefined timing separation threshold to cause the network element to generate an estimated location of a user equipment (UE) based on the at least one UL CP measurement and the at least one UL timing measurement. In the same example, the apparatus may embody additional aspects and/or include additional means for performing additional operations of the above-described methods.

In at least one embodiment, a method is provided that includes causing provision of a request to a user equipment (UE), wherein the request instructs the UE to maintain time separation between respective timestamps of DL carrier phase (CP) measurements and DL timing measurements within a predefined timing separation threshold; and receiving, from the UE, at least one DL CP measurement and at least one DL timing measurement, wherein a timing separation between respective timestamps of the at least one DL CP measurement and the at least one DL timing measurement is within the predefined timing separation threshold.

In some embodiments, the method includes receiving, from a positioning reference unit (PRU), at least one PRU CP measurement and a respective timestamp for the at least one PRU CP measurement; and providing an instruction to the UE to generate an estimated location of the UE based on the at least one PRU CP measurement and the at least one DL timing measurement, wherein the timing separation between the timestamp of the at least one DL timing measurement and the timestamp of the at least one PRU CP measurement satisfies the predefined timing separation threshold. In some embodiments, the method includes receiving, from a PRU, at least one PRU CP measurement and a respective timestamp for the at least one PRU CP; and generating an estimated location of the UE based on the at least one DL CP measurement, the at least one DL timing measurement, and one of the at least one PRU CP measurement wherein the time separations between the timestamps of the at least one DL CP measurement and at least one DL timing measurement and between the timestamps of the at least one DL timing measurement and the at least one PRU CP measurement satisfy the predefined timing separation threshold.

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to cause provision of a request to a user equipment (UE), wherein the request instructs the UE to maintain time separation between respective timestamps of UE carrier phase (CP) measurements and DL timing measurements within a predefined timing separation threshold; and receive, from the UE, at least one DL CP measurement and at least one DL timing measurement wherein a respective timing separation between respective timestamps of the at least one DL CP measurement and the at least one DL timing measurement is within the predefined timing separation threshold. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to cause provision of a request to a user equipment (UE), wherein the request instructs the UE to maintain time separation between respective timestamps of UE carrier phase (CP) measurements and DL timing measurements within a predefined timing separation threshold; and receive, from the UE, at least one DL CP measurement and at least one timing measurement, wherein a respective timing separation between respective timestamps of the at least one DL CP measurement and the at least one DL timing measurement is within the predefined timing separation threshold. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for causing provision of a request to a user equipment (UE), wherein the request instructs the UE to maintain time separation between respective timestamps of UE carrier phase (CP) measurements and DL timing measurements within a predefined timing separation threshold; and means for receiving, from the UE, at least one DL CP measurement and at least one DL timing measurement, wherein a respective timing separation between respective timestamps of the at least one DL CP measurement and the at least one DL timing measurement is within the predefined timing separation threshold. In the same example, the apparatus may embody additional aspects and/or include additional means for performing additional operations of the above-described methods.

In at least one embodiment, a method is provided that includes causing provision of a request to multiple transmission reception points TRPs, wherein the request instructs the multiple TRPs to report UL CP measurements and UL timing measurements for which a timing separation of respective timestamps for the UL CP measurement and UL timing measurement satisfies a predefined timing separation threshold; receiving, from the multiple TRPs, UL CP measurements, UL timing measurements, and respective timestamps for the UL CP measurements and UL timing measurements; determining, from the UL CP measurements and UL timing measurements, at least one UL CP measurement and at least one UL timing measurement for which a respective timing separation between respective timestamps of the at least one UL CP measurement and the at least one UL timing measurement is within the predefined timing separation threshold; and generating an estimated location of a UE based on the at least one UL CP measurement and the at least one UL timing measurement. In some embodiments, the steps are performed by a location management function (LMF). In some embodiments, the multiple TRPs generate the UL CP measurements and UL timing measurements based on the received uplink sounding reference signals from the UE and a positioning reference unit (PRU).

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to cause provision of a request to multiple transmission reception points TRPs, wherein the request instructs the multiple TRPs to report UL CP measurements and UL timing measurements for which a timing separation of respective timestamps for the UL CP measurement and UL timing measurement satisfies a predefined timing separation threshold; receive, from the multiple TRPs, UL CP measurements, UL timing measurements, and respective timestamps for the UL CP measurements and UL timing measurements; determine, from the UL CP measurements and UL timing measurements, at least one UL CP measurement and at least one UL timing measurement for which a respective timing separation between respective timestamps of the at least one UL CP measurement and the at least one UL timing measurement is within the predefined timing separation threshold; and generate an estimated location of a UE based on the at least one UL CP measurement and the at least one UL timing measurement. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to cause provision of a request to multiple transmission reception points TRPs, wherein the request instructs the multiple TRPs to report UL CP measurements and UL timing measurements for which a timing separation of respective timestamps for the UL CP measurement and UL timing measurement satisfies a predefined timing separation threshold; receive, from the multiple TRPs, UL CP measurements, UL timing measurements, and respective timestamps for the UL CP measurements and UL timing measurements; determine, from the UL CP measurements and UL timing measurements, at least one UL CP measurement and at least one UL timing measurement for which a respective timing separation between respective timestamps of the at least one UL CP measurement and the at least one UL timing measurement is within the predefined timing separation threshold; and generate an estimated location of a UE based on the at least one UL CP measurement and the at least one UL timing measurement. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for means for causing provision of a request to multiple transmission reception points TRPs, wherein the request instructs the multiple TRPs to report UL CP measurements and UL timing measurements for which a timing separation of respective timestamps for the UL CP measurement and UL timing measurement satisfies a predefined timing separation threshold; means for receiving, from the multiple TRPs, UL CP measurements, UL timing measurements, and respective timestamps for the UL CP measurements and UL timing measurements; means for determining, from the UL CP measurements and UL timing measurements, at least one UL CP measurement and at least one UL timing measurement for which a respective timing separation between respective timestamps of the at least one UL CP measurement and the at least one UL timing measurement is within the predefined timing separation threshold; and means for generating an estimated location of a UE based on the at least one UL CP measurement and the at least one UL timing measurement. In the same example, the apparatus may embody additional aspects and/or include additional means for performing additional operations of the above-described methods.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 shows an overview of new radio (NG) downlink carrier phase positioning.

FIG. 2 shows an integer ambiguity grid that illustrates resolution of the integer ambiguity problem using the described techniques for valid reporting of timing measurements.

FIG. 3 illustrates an example of a communication network in which an example embodiment of the present disclosure may be implemented;

FIG. 4 illustrates a block diagram of an apparatus that may be configured in accordance with an example embodiment of the present disclosure;

FIG. 5 illustrates a signal diagram for downlink carrier phase positioning (DL CPP) in a UE-based mode in accordance with an example embodiment of the present disclosure;

FIG. 6 illustrates a signal diagram for DL CPP in a UE-based mode in accordance with an example embodiment of the present disclosure;

FIG. 7 illustrates a signal diagram for uplink carrier phase positioning (ULCPP) in accordance with an example embodiment of the present disclosure;

FIG. 8 illustrates an example flowchart of a DL CPP process in accordance with an example embodiment of the present disclosure; and

FIG. 9 illustrates an example flowchart of a UL CPP process in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with the described embodiments. Thus, use of any such terms should not be taken to limit the spirit and scope of the embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to signal, non-transitory computer-readable medium and the like. The term ‘non-transitory computer-readable medium’ refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

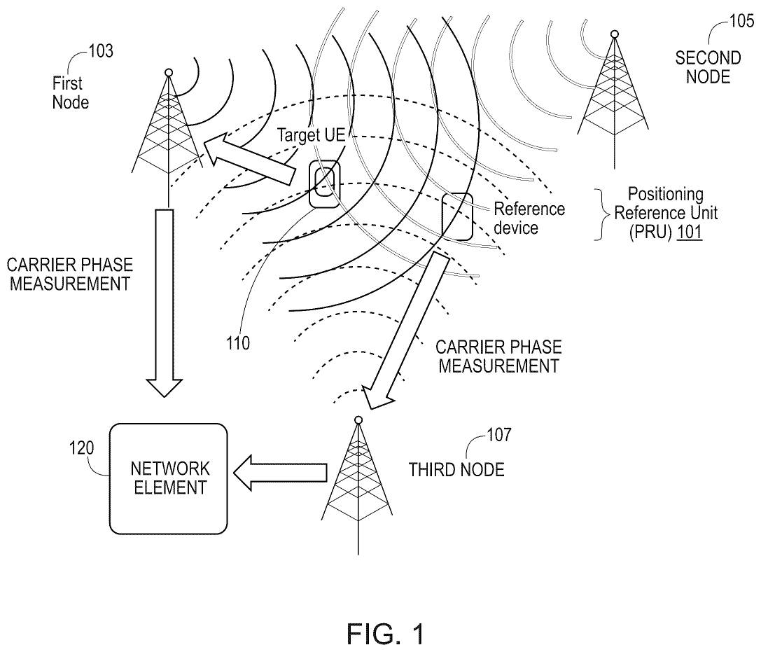

FIG. 1 shows an overview of new radio (NR) downlink carrier phase positioning (DL CPP). In some embodiments, in the DL CPP technique, the downlink positioning reference signals (DL PRS) are transmitted by multiple transmission and reception points (TRPs) to the target UE and the positioning reference unit (PRU). For example, as shown in FIG. 1, multiple nodes 103, 105, 107 may transmit DL PRS to a target UE 110. In some embodiments, DL-based CPP is performed using a UE-assisted mode or a UE-based mode. In the UE-assisted mode, the target UE 110 and a positioning reference unit (PRU) 101 may measure the DL reference signal carrier phase (RSCP) measurements and report them to a network element 120. In some embodiments, the network element 120 embodies a location management function. In some embodiments, the network element 120 calculates the location of the target UE 110 based on the legacy timing measurements, the phase measurements (e.g., made by target UE 110 and PRU 101) and the locations of TRPs (e.g., nodes 103, 105, 107). In some embodiments, legacy timing measurements include DL time difference of arrival (DL-TDOA), UL time difference of arrival (UL-TDOA), DL angle of departure (DL-AoD), UL angle of arrival (UL-AoA), and metrics from multi-cell round trip time (Multi-RTT) positioning methods. As used herein, CP measurements and corresponding timing measurements generated by a UE may be referred to, respectively, as downlink (DL) CP measurements and DL timing measurements. As used herein, CP measurements and corresponding timing measurements generated by a network node or obtained by network node from a TRP may be referred to, respectively, as uplink (UL) CP measurements and UL timing measurements.

Alternatively, in the UE-based mode, the target UE 110 may measure the DL RSCP measurements and receive simultaneous PRU measurements from the network element 120. In some embodiments, in the UE-based mode, the target UE 110 calculates its own location based on the legacy timing measurements, the phase measurements the target UE 110 itself performs, the reference device measurements received from the network element 120, and the known locations of TPRs (e.g., nodes 103, 105, 107) and the PRU 101.

In some embodiments, the target UE 110 and the PRU 101 transmit respective uplink sounding reference signals (UL SRS) to the multiple TRPs in a Next Generation Radio Access Network (NG-RAN) node-assisted UL-based CP. In some embodiments, the multiple TPRs generate respective reference signal carrier phase (RSCP) measurements of the UL SRS. In some embodiments, the multiple TRPs transmit the respective RSCP measurements of the UL SRS to the network element 120. In some embodiments, the network element 120 estimates the location of the target UE 110 based on the legacy timing measurements, the phase measurements (e.g., of the target UE 110 and PRU 101) and the known locations of the TRPs and PRU 101.

In some embodiments, for transmitted positioning reference signal (PRS) resources from an i^{th} TRP, the phase measurement at the k^{th} UE is given by Equation 1. In some embodiments, in Equation 1,

$${φ}_{i k} = \frac{1}{2 π} {\hat{φ}}_{i k}$$

is used to denote the phase measurement in cycles and to leave out repeated use of 2π. In some embodiments, dᵢₖ, c, δₖ, δᵢ, and Nᵢₖ represent the actual geographical distance between the k^{th} UE and the i^{th} TRP, speed of light, internal clock bias at the k^{th} UE, internal clock bias at the i^{th} TRP, and integer ambiguity of the propagated wavelength, respectively.

$${φ}_{ik} = {d}_{ik} + c ( {δ}_{k} - {δ}_{i} ) + λ {N}_{i k} , \qquad ( Equation 1 )$$

In some embodiments, the Equation 1 can be derived for the phase measurement from the j^{th} TRP such that φⱼₖ=dⱼₖ+c (δₖ−δⱼ)+λNⱼₖ.

In some embodiments, the unknown phase shifts due to the oscillator phases at the TRP, and UE can add additional ambiguity to the estimated phase and impair the positioning estimation accuracy. In some embodiments, a single difference measurement can be used to eliminate the internal clock bias at the k^{th} UE by subtracting φⱼₖ from φᵢₖ to calculate reference signal CP difference (RSCPD) measurements according to Equation 2. In some embodiments, in Equation 2, Δφᵢⱼ^{k}=φᵢₖ−φⱼₖ, Δdᵢⱼ^{k}=dᵢₖ−dⱼₖ, Δδᵢⱼ^{k}=δⱼ−δᵢ, and ΔNᵢⱼ^{k}=Nᵢₖ−Nⱼₖ.

$${Δφ}_{i j}^{k} = Δ {d}_{i j}^{k} + c Δ {δ}_{i j}^{k} + λ Δ {N}_{i j}^{k} , \qquad ( Equation 2 )$$

In some embodiments, from the single differential operation, the UE clock bias is cancelled. In some embodiments, clock error between TRPs is removed by conducting the double difference measurements, which may include subtracting the single-differenced measurements of a PRU from that of the k^{th} UE.

For example, assuming that the p^{th} UE is the PRU. For the transmitted PRS resource from the i^{th} and j^{th} TRPs to the p^{th} PRU, the RSCPD measurement may be written as Equation 3, where Δφᵢⱼ^{p}=φᵢₚ−φⱼₚ, Δdᵢⱼ^{p}=dᵢₚ−dⱼₚ, Δδᵢⱼ^{p}=δⱼ−δᵢ, and ΔNᵢⱼ^{p}=Nᵢₚ−Nⱼₚ.

$${Δφ}_{i j}^{p} = Δ {d}_{i j}^{p} + c Δ {δ}_{i j}^{p} + λ Δ {N}_{i j}^{p} , \qquad ( Equation 3 )$$

In some embodiments, the clock errors between the i^{th} and j^{th} TRPs (e.g., Δδᵢⱼ^{p} and Δδᵢⱼ^{k}) are a common term between Δφᵢⱼ^{p} and Δφᵢⱼ^{k} and do not depend on the UE/PRU index under some conditions. In some embodiments, the clock errors may be eliminated by subtracting Δφᵢⱼ^{p} from Δφᵢⱼ^{k} according to Equation 4, where ΔΔφᵢⱼ^{kp}=Δφᵢⱼ^{k}−Δφᵢⱼ^{p}, ΔΔdᵢⱼ^{kp}=Δdᵢⱼ^{k}−Δdᵢⱼ^{p}, and ΔΔNᵢⱼ^{kp}=ΔNᵢⱼ^{k}−ΔNᵢⱼ^{p}. The clock error between the UE and TRP and clock errors between TRPs may be cancelled out using the single and double differential measurements, respectively. The only remaining ambiguity is the integer ambiguity parameter (e.g., ΔΔNᵢⱼ^{kp}). In some embodiments, the entity calculating the UE location (e.g., the UE in DL CPP UE-based mode or the LMF in DL CPP UE-assisted and UL CPP NG-RAN node-assisted modes) estimates ΔΔNᵢⱼ^{kp} using the associated timing measurements with the CP measurements of the target UE and PRU. In typical approaches, this is done assuming an alignment between the CP measurements and their corresponding timing measurements (e.g., both are obtained from the same time/frequency resources and reported almost at the same time). However, misalignment between the timing measurements and CP measurements of the target UE and/or PRU may result in CP measurement error due to stale timing measurement information, which may result in incorrect estimations of current UE location. In various embodiments, the present methods, apparatuses, and computer program products overcome the technical challenges of ensuring alignment between CP and timing measurements at least in part by providing a predefined time separation threshold to constrain CP and timing measurement usage based on those measurements that demonstrate a timing separation within the predefined time separation threshold.

$${ΔΔφ}_{i j}^{k p} = ΔΔ {d}_{i j}^{k p} + λΔΔ {N}_{i j}^{k p} \qquad ( Equation 4 )$$

In some embodiments, downlink (DL) reference signal carrier phase (RSCP) is reported together with a UE receive (Rx)−transmission (Tx) time difference measurement. In some embodiments, DL RSCPD is reported together with a reference signal time difference (RSTD) measurement. In some embodiments, a TRP is configured to report uplink (UL) together with relative time of arrival (RTOA) and/or node Rx-Tx time difference measurements to an LMF. In some embodiments, the report of UL CP measurement with node Rx-Tx time difference does not require report of DL CP measurement with UE Rx-Tx time difference (e.g., but standalone UL carrier phase measurement reporting is not precluded).

In some embodiments, a timestamp associated with a reported RSCP/RSCPD embodies “NR-TimeStamp” as defined in TS 37.355 and comprises the granularity of a slot. Alternatively, in some embodiments, the timestamp, embodied as NR-TimeStamp, is enhanced to include the orthogonal frequency division multiplexing (OFDM) symbol index in the slot. For example, a UE, TRP, and/or the like may provide an OFDM symbol index in a timestamp for a timing measurement, CP measurement, and/or the like. In some embodiments, each DL RSCP/RSCPD measurement instance is obtained with a single sample. In some embodiments, combining the RSCP/RSCPD measurements from different positioning reference signal (PRS) instances may not be useful in CPP as the values of carrier phases can change significantly between different PRS instances leading to the loss of phase coherence between the different samples. In some embodiments, a legacy timing measurement that is obtained from multiple samples (e.g., 2 or 4 samples) may be associated with multiple CP measurements (e.g., 2 or 4 CP measurements). For example, subject to the capability of a UE, if a UE Rx-Tx time difference and/or DL RSTD measurement is obtained with 2 or 4 samples, the UE Rx-Tx time difference and/or DL RSTD measurement may be associated and reported together with 2 or 4 RSCP/RSCPD measurements. In some embodiments, a single RSCP/RSCPD measurement is obtained within one sample and each RSCP/RSCPD measurement may be associated with a respective timestamp. Various embodiments of the present disclosure provide signaling techniques for minimizing and/or limiting the time separation between the timestamps of CP measurements and their corresponding timing measurements to ensure alignment and, thereby, resolve CPP integer ambiguity challenges described herein.

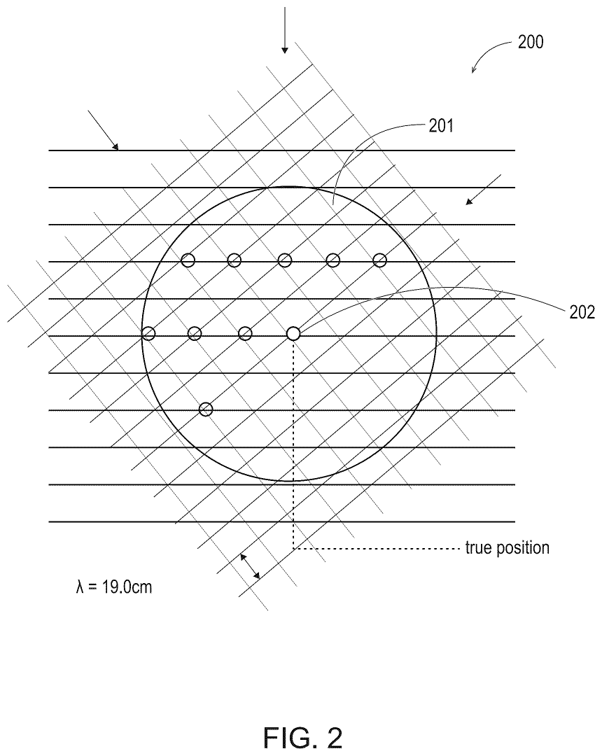

FIG. 2 shows an integer ambiguity grid 200 that illustrates resolution of the integer ambiguity problem using the described techniques for valid reporting of timing measurements. In various embodiments, the integer ambiguity grid 200 represents the wavefronts from three network nodes (e.g., gNodeBs(gNBs)) are with three groups of parallel lines, where the lines of each line group are separated by equal distance representing the propagated wavelength. In some embodiments, the intersections of the wavefronts from the three gNBs represent the possible locations of the UE. In some embodiments, the shaded area 201 (represented by a circle) represents the reduced search space of a few candidate UE locations using the unambiguous timing measurements to estimate the integer ambiguity parameters in ΔΔNᵢⱼ^{kp}. In various embodiments, for accurate CPP, the true UE location 202 (e.g., depicted as the small white circle) should be located within the gray shaded area 201. Otherwise, the timing measurement may fail to resolve the integer ambiguity problem and incorrectly estimate the correct UE location.

In various embodiments, the present methods, apparatuses, and computer program products ensure that the time separation between the timestamps of timing measurements and the corresponding CP measurements is within a certain predefined/configured threshold. In doing so, the entity calculating the UE location may accurately estimate the unknown number of complete phase cycles the reference signal has travelled and, thereby, resolve the integer ambiguity problem and achieve CPP estimation accuracy. Without this alignment, the true UE location 202 (e.g., the small white circle) will be located outside the area 201, and the timing measurements will fail to resolve the integer ambiguity problem leading to either the failure of the CPP method or (in its best case) achieving an accuracy that is far less than the target CPP accuracy.

For example, the radius of the integer ambiguity grid may be about 4λ (e.g., 80 cm). Thus, if the true UE location 202 at t=t2 based on CP measurement is different more than 80 cm of the UE location at t=t1 based on timing measurement, it may be infeasible to determine the ambiguous integer values. In various embodiments, the present techniques for CPP use a valid timestamp of the received timing measurements (associated with the CP measurements) to resolve the integer ambiguity of the CP measurements to improve the overall positioning estimation accuracy.

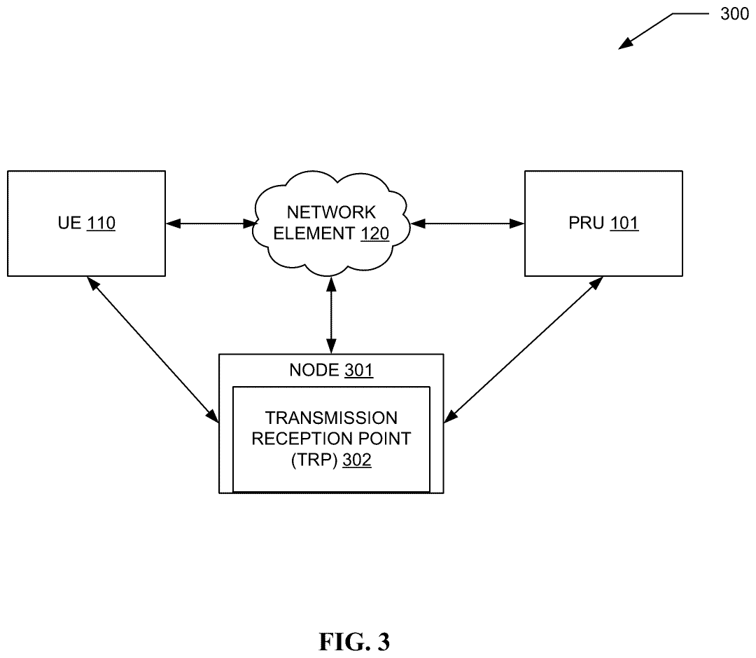

As illustrated in FIG. 3, a communication network 300 is provided in accordance with various embodiments of the present disclosure. In some embodiments, the communication network 300 includes one or more UE 110, one or more positioning reference units (PRUs) 110, one or more nodes 301 comprising multiple transmission reception points (TRPs) 302, and a network element 120. In some embodiments, the network element 120 is in communication with the UE 110, PRU 101, and nodes 301. In some embodiments, the nodes 301 further communicate with the UE 110 and PRU 101. In some embodiments, the nodes 301 embody gNodeBs, and/or the like, that serve UEs 110. By way of example, the network 300 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunications system (UMTS) radio access network (UTRAN, E-UTRAN or NG-RAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 110 may be any type of user terminal, terminal device, etc. to which resources on the air interface are allocated and assigned. For example, the UE may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user equipment may also be called a subscriber unit, mobile station, remote terminal, access terminal, user terminal or user equipment (UE) just to mention but a few names or apparatuses. In some embodiments, carrier phase (CP) measurements and corresponding timing measurements generated by the UE 110 may be referred to, respectively, as downlink (DL) CP measurements and DL timing measurements. In some embodiments, CP measurements and corresponding timing measurements generated by the network node 301 or obtained by the network node 301 from a TRP 302 may be referred to, respectively, as uplink (UL) CP measurements and UL timing measurements.

The network element 120 may be any combination of firmware, hardware, software, and/or the like that provides positioning functionality for estimating the geographic position of the UE 110 based on downlink and/or uplink radio signals including carrier phase (CP) measurements, corresponding timing measurements, and their respective timestamps. In some embodiments, the network element 120 generates and provisions time separation thresholds to the UE 110, node(s) 301, and PRU 101. In some embodiments, the network element 120 instructs or requests the UE 110 to maintain a time separation between the timestamps of CP and timing measurements within the predefined time separation threshold.

In some embodiments, the network element 120 receives CP measurements, corresponding timing measurements, and their respective timestamps from the UE 110, node 301, PRU 101, and/or the like. In some embodiments, the network element 120 receives UE mobility profiles from the node 301. In some embodiments, the network element 120 generates the predefined time separation threshold based on the UE mobility profile. In some embodiments, the network element 120 forwards CP measurements, corresponding timing measurements, and/or their respective timestamps received from the PRU 101 to the UE 110. In some embodiments, the network element 120 instructs or requests the UE 110 to use PRU CP measurements and PRU timing measurements, for which the respective timestamps that fall (from the timestamps of the DL CP measurements) within the predefined time separation threshold configured by the network element 120 at the UE 110. In some embodiments, the network element 120 generates an estimated location of a UE 110 based on CP measurements and corresponding timing measurements that satisfy a predefined time separation threshold based on their respective timestamps.

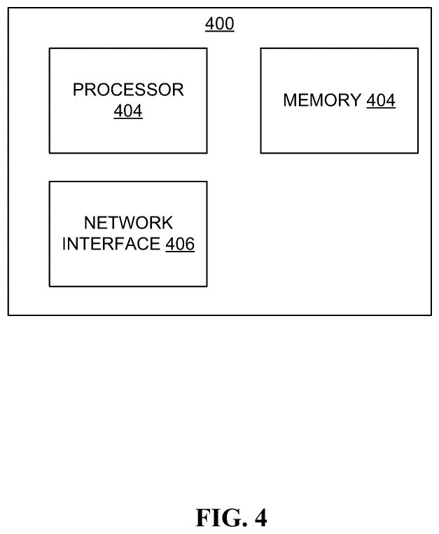

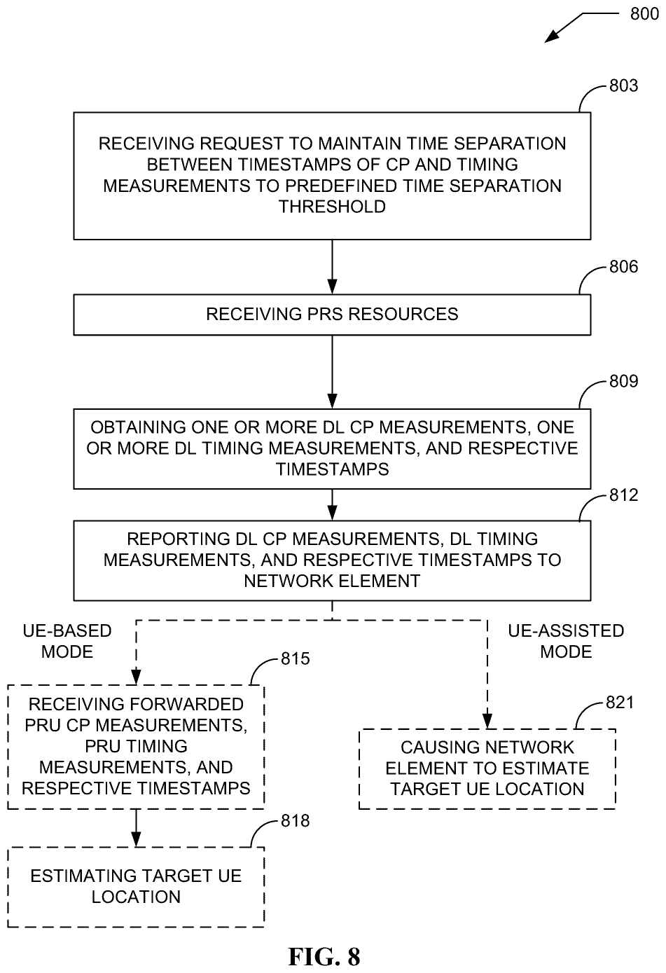

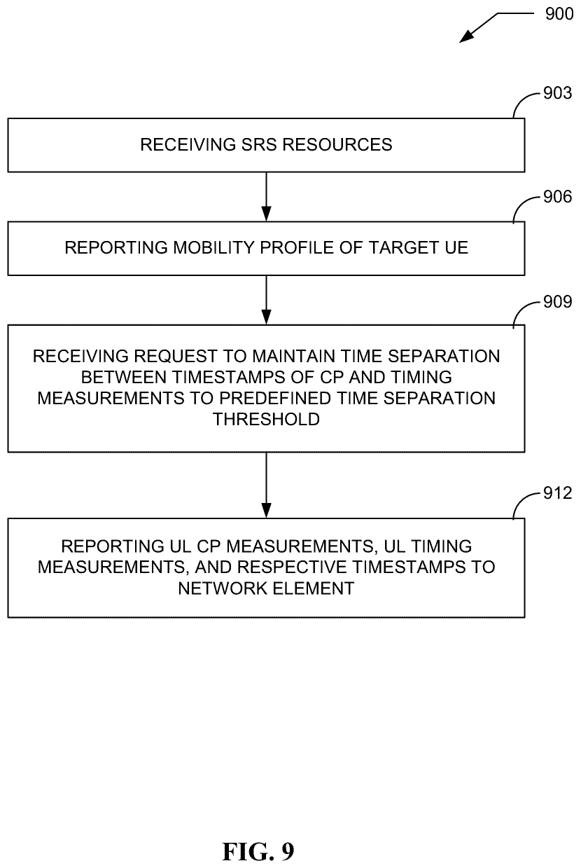

FIG. 4 shows an example apparatus 400 according to one embodiment. The apparatus 400 may be an embodiment of a UE 110, PRU 101, or node 301. Regardless of the device that embodies the apparatus 400, the apparatus may include processor 402, memory 404, and network interface 406. The apparatus 400 may be configured to execute the operations described herein. For example, one or more of the apparatus 400 may be configured to perform the DL CPP process 800 shown in FIG. 8 and described herein. As another example, one or more of the apparatus 400 may be configured to perform the UL CPP process 900 shown in FIG. 9 and described herein.

Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 402 (and/or co-processor or any other processing circuitry assisting or otherwise associated with the processor) may be in communication with the memory 404 via a bus for passing information among components of the apparatus. The memory 404 is non-transitory and may include, for example, one or more volatile and/or non-volatile memories. In other words, for example, the memory 404 may be an electronic storage device (e.g., a non-transitory computer-readable storage medium). The memory 404 may be configured to store information, data, content, applications, instructions, or the like for enabling the apparatus to carry out various functions in accordance with an example embodiment disclosed herein.

The processor 402 may be embodied in a number of different ways and may, for example, include one or more processing devices configured to perform independently. In some non-limiting embodiments, the processor 402 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 402 may be configured to execute instructions stored in the memory 404 and/or circuitry otherwise accessible to the processor 402. In some embodiments, the processor 402 may be configured to execute hard-coded functionalities. As such, whether configured by hardware or software methods, or by a combination thereof, the processor 402 may represent an entity (e.g., physically embodied in circuitry) capable of performing operations according to an embodiment disclosed herein while configured accordingly. Alternatively, as another example, when the processor 402 is embodied as an executor of software instructions, the instructions may specifically configure the processor 402 to perform the algorithms and/or operations described herein when the instructions are executed.

In some embodiments, the apparatus 400 may optionally include input/output circuitry that may, in turn, be in communication with processor 402 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 404, and/or the like).

The network interface 406 may be any means such as a device or circuitry embodied in either hardware or a combination of hardware and software that is configured to receive and/or transmit data from/to a network and/or any other device, circuitry, or module in communication with the apparatus 400. In this regard, the network interface 406 may include, for example, a network interface for enabling communications with a wired or wireless communication network, such as the application function (AF), multicast and broadcast service function (MBSF), multicast and broadcast user plane function (MB-UPF), and/or multicast and broadcast session management function (MB-SMF). For example, the network interface 406 may include one or more network interface cards, antennae, buses, switches, routers, modems, and supporting hardware and/or software, or any other device suitable for enabling communications via a network. Additionally, or alternatively, the network interface 406 may include the circuitry for interacting with the antenna/antennae to cause transmission of signals via the antenna/antennae or to handle receipt of signals received via the antenna/antennae.

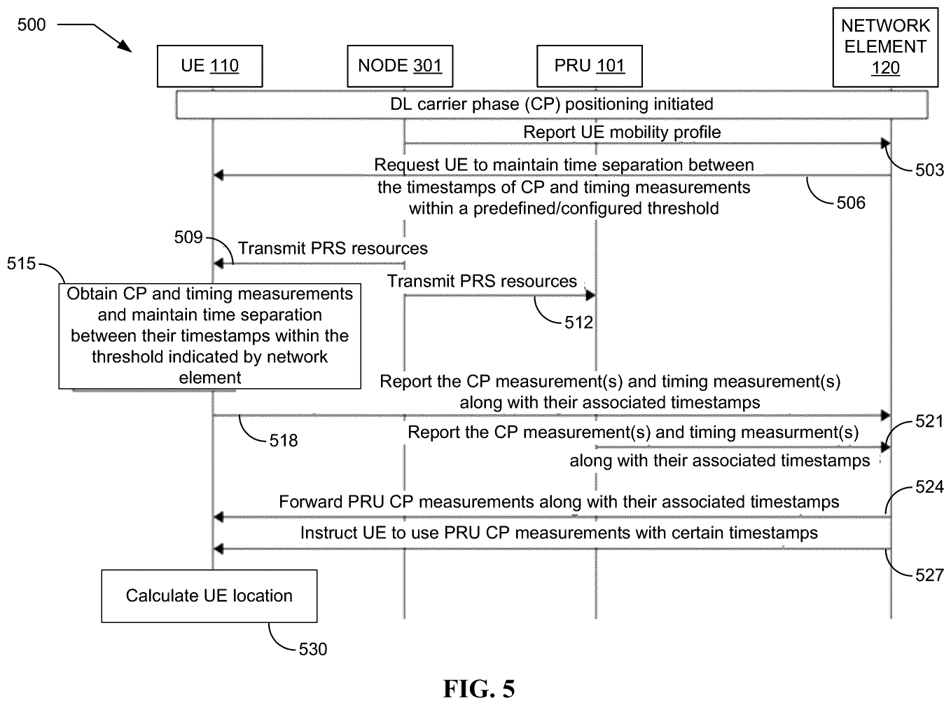

FIG. 5 shows a signal diagram for downlink carrier phase positioning (DL CPP) in a UE-based mode in accordance with an example embodiment of the present disclosure. As shown in FIG. 5, the node 301 may report a UE mobility profile for a target UE 110 to the network element 120 (signal 503). In some embodiments, the UE mobility profile includes the current velocity of the target UE 110 (e.g., vertical velocity, horizontal velocity, and/or the like) or an indication that the target UE 110 is stationary. In some embodiments, the network element 120 defines a time separation threshold based on the UE mobility profile. In some embodiments, the network element 120 provides the target UE 110 and the PRU 101 with assistance positioning data and requests the target UE 110 and PRU 101 to generate timing and CP measurements on one or more transmitted DL positioning reference signal (PRS) resources and/or resource sets. In some embodiments, the assistance positioning data includes PRS configuration information based on which the target UE 110 and PRU 101 obtain CP measurements, corresponding timing measurements, and their respective timestamps. In some embodiments, the network element 120 provides to the target UE 110 known locations of multiple TRPs for which CP measurements will be obtained and a known location of the PRU 101. In some embodiments, when initiating DL CPP, the network element 120 indicates to the target UE 110 (and potentially other communication network elements) whether the DL CPP will be UE-based or UE-assisted.

In some embodiments, the network element 120 requests the target UE 110 to maintain the time separation (e.g., distance) between the timestamps of CP and timing measurements within the predefined time separation threshold (signal 506). In some embodiments, the network element 120 provides a condition on reporting timestamps such that a difference of a timestamp (t1) for a CP measurement and another timestamp (t2) for a timing measurement should be less than a threshold X1. The target UE 110 may be requested to satisfy the time separation condition when it is reporting two timestamps for DL CP measurements and DL timing measurements. For example, if the DL CP measurements and DL timing measurements are associated with timestamps t1 and t2, respectively, the network element 120 requests the target UE 110 to maintain |t1−t2|<X1, where X1 corresponds to the predefined time separation threshold based on the UE mobility profile.

In some embodiments, the node 301 causes provision of DL positioning reference signal (PRS) resources to the target UE 110 and the PRU 101 (signals 509, 512). In some embodiments, the target UE 110 obtains CP measurements within 1 sample and corresponding timing measurements within 1, 2, or 4 samples for multiple TRPs (indicium 515). Additionally, the target UE 110 generates respective timestamps for the CP measurements and corresponding timing measurements, where the respective timestamps have a time separation that satisfies the predefined time separation threshold. In some embodiments, the target UE 110 obtains multiple CP measurements and corresponding timing measurements and generates a respective timestamp for each CP measurement and timing measurement, all or a subset of which may be reported by the target UE 110 to the network element 120. In some embodiments, in instances where the target UE 110 obtains multiple timing measurement samples, the target UE 110 may average over the multiple timing measurement samples to determine the timing measurement. In such instances, the target UE 110 may place greater weight on the most recent measurement sample, which may affect a timestamp for the timing measurement due to the weighting factors applied to the multiple measurement samples.

In some embodiments, the target UE 110 does not average over the multiple timing measurement samples and, instead, reports the multiple timing measurement samples (and corresponding timestamps) to the network element 120 to enable the network element 120 to consider the multiple samples when resolving integer ambiguity. In some embodiments, the target UE 110 performs CP measurements and timing measurements separately and may reuse timing measurements that have already been taken during a previous measurement occasion. In instances where the UE is static (e.g., zero velocity), the target UE 110 may use its timestamp for the CP measurements as a timestamp for the corresponding timing measurements while static.

In some embodiments, the target UE 110 reports to the network element 120 the DL CP measurements and DL timing measurements along with their respective timestamps that maintain a time separation in compliance with the predefined time separation threshold (signal 518). For example, if the DL CP measurements and DL timing measurements are associated with timestamps t1 and t2, respectively, the target UE 110 may obtain CP measurements and corresponding timing measurements and report them to the network element 120 along with their timestamps t1 and t2 that maintain a time distance X1, where X1 corresponds to the predefined time separation threshold. In some embodiments, the target UE 110 may report 1 CP measurement and 1, 2, or 4 timing measurement samples and their respective timestamps to the network element 120. In some embodiments, the target UE 110 reports to the network element 120 rough timing measurements that may be valid for search space reduction using the CP measurements, where the CP measurements are made later than the timing measurements. In some embodiments, the network element 120 requests the target UE 110 to report rough timing measurements that may be valid for current and/or future CP measurements, which may cause the target UE 110 to report the rough timing measurements at a different time than the CP measurements.

In some embodiments, the network element 120 receives one or more PRU CP measurements for the multiple TRPs, corresponding PRU timing measurements, and their respective timestamps from the PRU 101 (signal 521). In some embodiments, the network element 120 forwards the PRU CP measurements, corresponding PRU timing measurements, and respective timestamps to the target UE 110 (signal 524). In some embodiments, the network element 120 instructs the target UE 110 to use the PRU CP measurement(s) that have timestamp(s) that have a time separation with the DL timing measurement timestamp that is within the predefined time separation threshold (signal 527). For example, if the DL timing measurement has a timestamp t1 and the CP measurement of the PRU has a timestamp t3, the network element 120 may instruct the target UE 110 to only use the PRU CP measurements with a timestamp t3 that satisfy |t1−t3|<X1, where X1 is the predefined time separation threshold. In some embodiments, the target UE 110 generates an estimated location for itself based on i) the one or more DL CP measurements, corresponding DL timing measurements, and respective timestamps that satisfy the predefined time separation threshold, ii) the one or more PRU CP measurements, corresponding PRU timing measurements, and respective timestamp(s) that satisfy the predefined time separation threshold, and iii) the known locations of the TRPs and PRU 101 (indicium 530). In some embodiments, the target UE 110 uses double-differenced CP measurements generated based on the one or more UE-sourced CP measurements and the one or more PRU CP measurements for which a timing separation of the corresponding timestamps is within the predefined time separation threshold. In some embodiments, the target UE 110 uses the DL timing measurements for which the corresponding timestamps satisfy a separation from the timestamps of the DL CP measurements within the predefined time separation threshold to solve the integer ambiguity problem in the double-differenced CP measurements. In some embodiments, the target UE 110 uses the double-differenced CP measurements to generate the estimated location for itself.

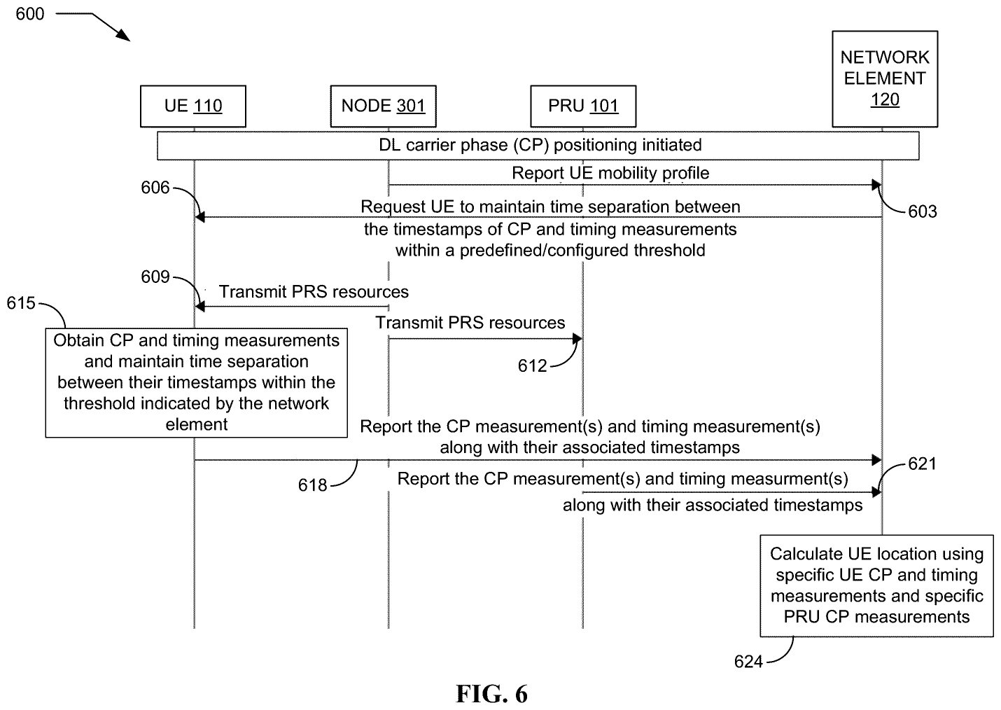

FIG. 6 shows a signal diagram for DL CPP in a UE-based mode in accordance with an example embodiment of the present disclosure. As shown in FIG. 6, the DL CPP in UE-based mode includes signals/indicia 603, 606, 609, 612, 615, 618, and 621, which may be performed similar to signals/indicia 503, 506, 509, 512, 515, 518, and 521 respectively, shown in FIG. 5 and described herein. In some embodiments, the network element 120 receives from the target UE 110 one or more DL CP measurements, corresponding DL timing measurements, and respective timestamps that satisfy a predefined time separation threshold. In some embodiments, the network element 120 receives from the PRU 101 one or more PRU CP measurements, respective timestamp(s) that satisfy the predefined time separation threshold, corresponding PRU time measurements, and respective timestamp(s). In some embodiments, the network element 120 generates an estimated location of the target UE 110 based on i) the one or more DL CP measurements, corresponding DL timing measurements, and respective timestamps that satisfy the predefined time separation threshold, ii) the one or more PRU CP measurements, respective timestamp(s) that satisfy the predefined time separation threshold, PRU timing measurements, and respective timestamp(s) and iii) the known locations of the TRPs and PRU 101 (indicium 624).

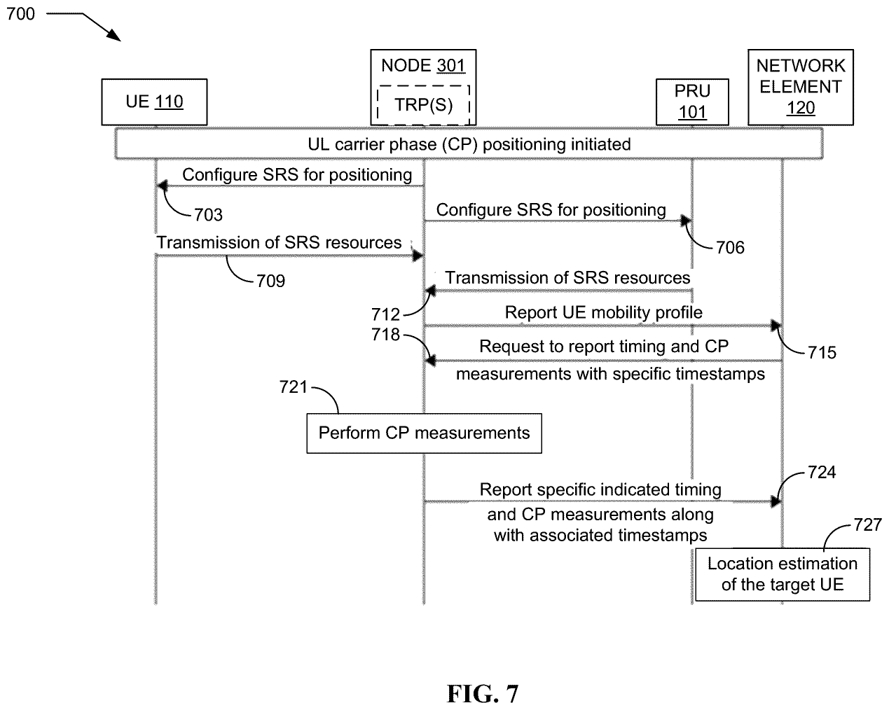

FIG. 7 shows a signal diagram for uplink carrier phase positioning (ULCPP) in accordance with an example embodiment of the present disclosure. As shown in FIG. 7, the node 301 may configure SRS for positioning at the target UE 110 and the PRU 101 (signals 703, 706). In some embodiments, the target UE 110 and PRU 101 request the node 301 to provide UL sounding reference signal (SRS) resources for positioning and transmit the configured UL SRS resources to multiple TRPs. In some embodiments, the node 301 receives SRS resources from the target UE 110 and PRU 101 (signals 709, 712). In some embodiments, the node 301 performs UL CP measurements and UL timing measurements based on UL SRS received from the UE and PRU. In some embodiments, the node 301 reports a UE mobility profile for the target UE 110 to the network element 120 (signal 715). In some embodiments, the UE mobility profile includes the current velocity of the target UE 110 or an indication that the target UE 110 is stationary.

In some embodiments, the network element 120 defines a time separation threshold based on the UE mobility profile. In some embodiments, via communication with the node 301, the network element 120 requests one or more TRPs to report UL timing and UL CP measurements based on received SRS transmissions from the target UE 110 and the PRU 101 that maintain a time separation between them that satisfies the predefined separation threshold (signal 718). For example, if the timing and CP measurements obtained based on the received UL SRS from the target UE 110 have t1 and t2 timestamps, the network element 120 may request the TRP(s) to maintain t1 and t2 within |t1−t2|<X1, where X1 is the time separation threshold. Additionally, if the CP measurements obtained based on the received UL SRS from the PRU 101 have t3 timestamp, the network element 120 may request the TRP(s) to maintain t3 within the same predefined separation threshold from t1 (e.g., |t1−t3|<X1).

In some embodiments, the one or more TRPs associated with the node 301 obtain CP measurements, timing measurements, and corresponding timestamps based on the received UL SRS from the target UE 110 and PRU 101, where a time separation of the respective timestamps may satisfy the predefined time separation threshold (indicium 721). In some embodiments, the TRP reports to the network element 120 the DL CP measurements, DL timing measurements, PRU CP measurements, PRU timing measurements, and their respective timestamps that satisfy the predefined time separation threshold (signal 724). In some embodiments, the TRP may not need to send the CP measurements obtained based on the received UL SRS from the PRU for which the corresponding timestamp violates the predefined time separation threshold. For example, if the PRU CP measurements have t4 timestamp that is |t1−t4|>X1, where t1 is the associated timestamp with timing measurements obtained based on the received UL SRS from the UE, the TRP may not report some or all of the PRU CP measurements to the network element 120. In some embodiments, the network element 120 generates an estimated location of the target UE 110 based on i) the one or more DL CP measurements, corresponding DL timing measurements, and respective timestamps that satisfy the predefined time separation threshold, ii) the one or more PRU CP measurements, respective timestamp(s) that satisfy the predefined time separation threshold, PRU timing measurements, and respective timestamp(s), and iii) the known locations of the TRPs and PRU 101 (indicium 727).

In various embodiments, the workflows shown in FIGS. 5-7 enable resolution of integer ambiguity issues in the DL CPP and UL CPP by ensuring the alignment of CP measurements and timing measurements from target UEs, PRUs, and/or TRPs. In doing so, the workflows shown in FIGS. 5-7 may improve CPP measurement performance and positioning estimation accuracy.

Referring now to FIG. 8., shown is an example flowchart of a DL CPP process 800, which may be performed by an apparatus, such as the apparatus 400 of FIG. 4 (e.g., which may comprise the user equipment (UE) 110 shown in FIG. 1).

In some embodiments, at block 803, the apparatus performing the process 800 includes means, such as the processor 402, the memory 404, the network interface 406, or the like, for receiving a request to maintain time separation between respective timestamps of CP measurements and timing measurements to a predefined time separation threshold. For example, the apparatus 400 may receive from an network element 120 a condition on reporting timestamps such that a difference of a timestamp (t1) for a CP measurement and another timestamp (t2) for a timing measurement should be less than a threshold X1. In some embodiments, the predefined time separation threshold is based on a mobility profile. In some embodiments, the network element 120 reconfigures the time separation threshold based on a change to the mobility profile, such as a chance in UE velocity. In some embodiments, at block 806, the apparatus performing the process 800 includes means, such as the processor 402, the memory 404, the network interface 406, or the like, for receiving PRS resources. For example, the apparatus 400 may receive from the network element 120 PRS configuration information.

In some embodiments, at block 809, the apparatus performing the process 800 includes means, such as the processor 402, the memory 404, the network interface 406, or the like, for obtaining one or more DL CP measurements, one or more DL timing measurements, and their corresponding timestamps for one or more TRPs. For example, the apparatus 400 may generate DL CP measurements wherein each DL CP measurement is obtained using 1 sample and corresponding DL timing measurements obtained using 1, 2, or 4 samples for multiple TRPs. Additionally, the apparatus 400 may generate respective timestamps for the CP measurements and corresponding timing measurements, where the respective timestamps have a time separation that satisfies the predefined time separation threshold. In some embodiments, the apparatus 400 averages over multiple timing measurement samples to determine the DL timing measurement. Alternatively, in some embodiments, the apparatus 400 may not average over multiple timing measurement samples and, instead, report the multiple timing measurement samples (and corresponding timestamps) to the network element 120 to enable the network element 120 to consider the multiple samples when resolving integer ambiguity. In some embodiments, the apparatus 400 generates DL CP measurements and DL timing measurements separately and may reuse DL timing measurements that have already been taken during a previous measurement occasion.

In some embodiments, at block 812, the apparatus performing the process 800 includes means, such as the processor 402, the memory 404, the network interface 406, or the like, for reporting to the network element 120 one or more DL CP measurements, one or more DL timing measurements, and their corresponding timestamps that satisfy the predefined time separation threshold. For example, the apparatus 400 may generate DL CP measurements and DL timing measurements that are associated with timestamps t1 and t2, respectively. The apparatus 400 may report the DL CP measurements and DL timing measurements to the network element 120 along with their timestamps t1 and t2 that maintain a time separation |t1−t2|<X1, where X1 corresponds to the predefined time separation threshold. In some embodiments, the apparatus 400 reports 1, 2, or 4 DL CP measurements and 1 DL timing measurement and their respective timestamps to the network element 120. In some embodiments, the apparatus 400 reports to the network element 120 rough timing measurements that may be valid for search space reduction using the DL CP measurements, where the DL CP measurements are made later than the timing measurements.

In some embodiments, where the process 800 is performed in a UE-based mode, the process 800 may proceed from block 812 to blocks 815-818. Alternatively, in some embodiments, where the process 800 is performed in a UE-assisted mode, the process 800 may proceed to block 821.

In some embodiments, at block 815, the apparatus performing the process 800 includes means, such as the processor 402, the memory 404, the network interface 406, or the like, for receiving one or more forwarded PRU CP measurements, corresponding PRU timing measurements, and their respective timestamps from the network element 120 (e.g., the network element 120 having obtained the data from the PRU 101). Additionally, at block 815, the apparatus performing the process 800 receives from the network element 120 an instruction to use the PRU timing measurements and corresponding PRU CP measurements for which the respective timestamps satisfy the predefined time separation threshold from the timestamps of the timing measurements performed by the apparatus 400. For example, the apparatus 400 receives from the network element 120 one or more PRU CP measurements, corresponding PRU timing measurements, their respective timestamps, and an instruction to use only PRU CP measurements for which the respective timestamps satisfy the predefined time separation threshold from the timestamps of the timing measurements performed by the apparatus 400. For example, if the timing measurement performed by apparatus 400 has a timestamp t1 and the CP measurement performed by PRU 101 has a timestamp t3, the apparatus 400 may only use the PRU CP measurements with a timestamp t3 that satisfy |t1−t3|<X1, where X1 is the predefined time separation threshold.

In some embodiments, at block 818, the apparatus performing the process 800 includes means, such as the processor 402, the memory 404, the network interface 406, or the like, for estimating a location of the target UE (e.g., the apparatus itself). For example, the apparatus 400 may generate an estimated location for itself based on i) the one or more DL CP measurements, corresponding DL timing measurements, and respective timestamps that satisfy the predefined time separation threshold, ii) the one or more PRU timing measurements, respective timestamp(s), corresponding PRU CP measurements, and respective timestamp(s) that satisfy the predefined time separation threshold, and iii) the known locations of the TRPs and PRU.

Alternatively, in some embodiments, at block 818, the apparatus 400 performing the process 800 includes means, such as the processor 402, the memory 404, the network interface 406, or the like, for causing the network element 120 to estimate the location of the target UE. For example, the apparatus 400 may cause the network element 120 to generate an estimated location of the apparatus 400 based on i) the one or more DL CP measurements, corresponding DL timing measurements, and respective timestamps that satisfy the predefined time separation threshold, ii) the one or more PRU timing measurements, respective timestamp(s), corresponding PRU CP measurements, and respective timestamp(s) that satisfy the predefined time separation threshold, and iii) the known locations of the TRPs and PRU. In some embodiments, the apparatus 400 causes the network element 120 to estimate the location of the apparatus 400 at least in part by provisioning to the network element 120 the DL CP measurements, DL timing measurements, and respective timestamps that satisfy the predefined time separation threshold.

Referring now to FIG. 9., shown is an example flowchart of a UL CPP process 900, which may be performed by an apparatus, such as the apparatus 400 of FIG. 4, where the apparatus 400 embodies a node 301 and one or more TRPs.

In some embodiments, at block 903, the apparatus performing the process 900 includes means, such as the processor 402, the memory 404, the network interface 406, or the like, for receiving UL SRS resources. For example, the apparatus 400 receives a first set of SRS resources from a target UE 110 and a second set of UL SRS resources from the PRU 101. In some embodiments, at block 906, the apparatus performing the process 900 includes means, such as the processor 402, the memory 404, the network interface 406, or the like, for reporting a mobility profile of the UE 110 to the network element 120. For example, the apparatus 400 may obtain and report a UE mobility profile of the target UE 110 to the network element 120, where the UE mobility profile may indicate a velocity of the target UE 110.

In some embodiments, at block 909, the apparatus performing the process 900 includes means, such as the processor 402, the memory 404, the network interface 406, or the like, for receiving a request to maintain time separation between respective timestamps of CP measurements and timing measurements to a predefined time separation threshold. For example, the apparatus 400 may receive a threshold time separation X1 such that a difference of a timestamp (t1) for a CP measurement and another timestamp (t2) for a timing measurement reported by the apparatus 400 to the network element 120 should be less than the threshold X1.

In some embodiments, at block 912, the apparatus performing the process 900 includes means, such as the processor 402, the memory 404, the network interface 406, or the like, for reporting to the network element 120 one or more CP measurements, timing measurements performed based on received UL SRS from the UE, CP measurements, and timing measurements performed based on received UL SRS from the PRU, and their respective timestamps, where the respective timestamps satisfy the predefined time separation threshold. For example, the apparatus 400 may obtain (e.g., from the respective SRS resources of block 903) CP measurements, timing measurements, and corresponding timestamps based on the received UL SRS from the target UE 110 and PRU 101, where a time separation of the respective timestamps may satisfy the predefined time separation threshold. The apparatus 400 may report to the network element 120 the CP measurements and timing measurements performed based on received UL SRS from the UE, CP measurements and timing measurements performed based on received UL SRS from the PRU, and their respective timestamps that satisfy the predefined time separation threshold. In some embodiments, in reporting the CP and timing measurement data, the apparatus 400 causes the network element 120 to generate an estimated location of the target UE 110 based on i) the one or more CP measurements and corresponding timing measurements performed based on received UL SRS from the UE, and respective timestamps that satisfy the predefined time separation threshold, ii) the one or more CP measurements and timing measurements performed based on received UL SRS from the PRU, and respective timestamp(s) that satisfy the predefined time separation threshold, and iii) the known locations of the TRPs and PRU 101.

In various embodiments, the method, apparatus and computer program product of the present disclosure are provided for aligning the reporting of CP measurements and corresponding timing measurements to avoid CP measurement error due to stale timing measurement information. The method, apparatus, and computer program product provide improved solutions for resolving integer ambiguity issues in CPP processes. In various embodiments, the present techniques ensure that the time separation between the timestamps of timing measurements and the corresponding CP measurements is within a certain predefined/configured threshold. In doing so, the techniques may improve CPP measurement performance and positioning estimation accuracy.

It will be understood that each block of the flowcharts and combination of blocks in the flowcharts show in the figures and described herein may be implemented by various means, such as hardware, firmware, processor, circuitry, and/or communication devices associated with execution of software including one or more program instructions. For example, one or more of the procedures or operations described above may be embodied by computer program instructions. In this regard, the computer program instructions which embody the procedures or operations described above may be stored by a memory 404 of an apparatus (e.g., user equipment (UE)) employing a disclosed embodiment and executed by a processor 402. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. A method, comprising:
receiving, at a user equipment (UE), a request to maintain time separation between respective timestamps of carrier phase (CP) measurements and timing measurements within a predefined timing separation threshold; and
generating, at the UE, at least one downlink (DL) CP measurement associated with at least one timestamp, and at least one DL timing measurement associated with at least one DL timing measurement timestamp based on the predefined timing separation threshold, wherein a timing separation between the at least one timestamp and the at least one DL timing measurement timestamp is within the predefined timing separation threshold.

2. The method of claim 1, further comprising:
receiving, at the UE, at least one positioning resource unit (PRU) CP measurement, at least one PRU CP timestamp for the at least one PRU CP measurement, and an instruction from a network element, wherein:
the instruction instructs the UE to generate an estimated location of the UE using the at least one DL CP measurement, the at least one DL timing measurement, and one of the at least one PRU CP measurement; and
a timing separation between a timestamp of the PRU CP measurement and the at least one DL timing measurement timestamp of is within the predefined timing separation threshold; and
generating the estimated location of the UE based on the at least one DL CP measurement, the at least one DL timing measurement and one of the at least one PRU CP measurement, wherein a timing separation between the at least one timestamp and the at least one DL timing measurement timestamp of the is within the predefined timing separation threshold.

3. The method of claim 1, further comprising:
receiving, at the UE, a request to report CP measurements, timing measurements, and respective timestamps that satisfy the predefined timing separation threshold; and
in response to the request, causing provision of the at least one DL CP measurement, the at least one timestamp, the at least one DL timing measurement, and the at least one DL timing measurement timestamp from the UE to the receiver.

4. The method of claim 1, further comprising:
receiving, at the UE, DL positioning reference signal (PRS) resources from a network node, wherein:
the UE generates the at least one DL CP measurement, the at least one timestamp, the at least one DL timing measurement, and the at least one DL timing measurement timestamp based on the DL PRS resources.

5. The method of claim 1, further comprising:
causing provision of the at least one DL CP measurement, the at least one timestamp, the at least one DL timing measurement and, the at least one DL timing measurement timestamp from the UE to a network element to enable the network element to generate an estimated location of the UE based on:
the at least one DL CP measurement; and
the at least one DL timing measurement; and
at least one positioning reference unit (PRU) CP measurement and at least one PRU timing measurement received by the network element from a PRU, wherein:
a timing separation between the at least one DL timing measurement timestamp and a respective timestamp of the at least one PRU CP measurement satisfy the predefined timing separation threshold; and
a timing separation between the at least one timestamp and the at least one DL timing measurement timestamp satisfies the predefined timing separation threshold.

6. The method of claim 1, wherein:
the predefined timing separation threshold is based on a mobility profile of the UE.

7. The method of claim 1, further comprising:
receiving an updated timing separation threshold in response to a change to a mobility profile of the UE, wherein the change to the mobility profile is based on a change in a velocity of the UE.

8. An apparatus, comprising:
at least one processor; and
at least one memory storing instructions that, when executed by the at least one processor, cause the apparatus to:
receive a request to maintain time separation between respective timestamps of carrier phase (CP) measurements and timing measurements within a predefined timing separation threshold; and
generate at least one downlink (DL) CP measurement associated with at least one timestamp and at least one DL timing measurement associated with at least one DL timing measurement timestamp based on the predefined timing separation threshold, wherein a respective timing separation between the at least one timestamp and the at least one DL timing measurement timestamp is within the predefined timing separation threshold.

9. The apparatus of claim 8, wherein the instructions, when executed by the at least one processor, further cause the apparatus to:
receive at least one positioning reference unit (PRU) CP measurement performed by a PRU, at least one PRU CP timestamp for the at least one PRU CP measurement, and an instruction from a network element, wherein:
the instruction instructs the apparatus to generate an estimated location of the apparatus using the at least one DL CP measurement, the at least one DL timing measurement, and one of the at least one PRU CP measurement; and
a timing separation between the at least one PRU timestamp and the at least one DL timing measurement timestamp is within the predefined timing separation threshold; and
a timing separation between the at least one timestamp and the at least one DL timing measurement timestamp is within the predefined timing separation threshold; and
generate the estimated location of the apparatus based on the at least one DL CP measurement, the at least one DL timing measurement, and the PRU CP measurement.

10. The apparatus of claim 9, wherein the network element embodies a location management function (LMF) and any of the request to maintain time separation, request to report CP measurements, timing measurements, and the respective timestamps, or the updated timing separation threshold are received from the LMF.

11. The apparatus of claim 8, wherein the instructions, when executed by the at least one processor, further cause the apparatus to:
receive a request to report CP measurements, timing measurements, and respective timestamps that satisfy the predefined timing separation threshold; and
in response to the request, cause provision of the at least one DL CP measurement, the at least one timestamp, the at least one DL timing measurement, and the at least one DL timing measurement timestamp.

12. The apparatus of claim 8, wherein the instructions, when executed by the at least one processor, further cause the apparatus to:
receive DL positioning reference signal (PRS) resources from a network node, wherein:
the apparatus generates the at least one DL CP measurement and the at least one DL timing measurement based on the DL PRS resources.

13. The apparatus of claim 12, wherein the network node embodies a gNodeB.

14. The apparatus of claim 8, wherein the instructions, when executed by the at least one processor, further cause the apparatus to:
cause provision of the at least one DL CP measurement and the at least one DL timing measurement to a network element to enable the network element to generate an estimated location of the apparatus based on:
the at least one DL CP measurement; and
the at least one DL timing measurement; and
at least one positioning reference unit (PRU) CP measurement and at least one PRU timing measurement received by the network element from a PRU, wherein:
a timing separation between the at least one timestamp and a respective timestamp of the at least one PRU CP measurement satisfy the predefined timing separation threshold; and
a timing separation between the at least one timestamp and the at least one DL timing measurement timestamp satisfies the predefined timing separation threshold.

15. The apparatus of claim 8, wherein:
the predefined timing separation threshold is based on a mobility profile of the apparatus.

16. The apparatus of claim 15, wherein:
the mobility profile comprises a velocity of the apparatus.

17. The apparatus of claim 16, wherein the instructions, when executed by the at least one processor, further cause the apparatus to:
receive (503, 506) an updated timing separation threshold in response to a change to the mobility profile of the apparatus, wherein the change to the mobility profile is based on a change in the velocity of the apparatus.

18. An apparatus, comprising:
at least one processor; and
at least one memory storing instructions that, when executed by the at least one processor, cause the apparatus to:
cause provision of a request to a user equipment (UE), wherein the request instructs the UE to maintain time separation between respective timestamps of UE carrier phase (CP) measurements and downlink (DL) timing measurements within a predefined timing separation threshold; and
receive, from the UE, at least one DL CP measurement and at least one DL timing measurement wherein a respective timing separation between respective timestamps of the at least one DL CP measurement and the at least one DL timing measurement is within the predefined timing separation threshold.

19. The apparatus of claim 18, wherein the instructions, when executed by the at least one processor, further cause the apparatus to:
receive, from a positioning reference unit (PRU), at least one PRU CP measurement and a respective timestamp for the at least one PRU CP measurement; and
provide an instruction to the UE to generate an estimated location of the UE based on the at least one PRU CP measurement and the at least one DL timing measurement, wherein the timing separation between the timestamp of the at least one DL timing measurement and the timestamp of the at least one PRU CP measurement satisfies the predefined timing separation threshold.

20. The apparatus of claim 18, wherein the instructions, when executed by the at least one processor, further cause the apparatus to:
receive, from a PRU, at least one PRU CP measurement and a respective timestamp for the at least one PRU CP; and
generate an estimated location of the UE based on the at least one DL CP measurement, the at least one DL timing measurement, and one of the at least one PRU CP measurement, wherein the time separations between the timestamps of the at least one DL CP measurement and at least one DL timing measurement and between the timestamps of the at least one DL timing measurement and the at least one PRU CP measurement satisfy the predefined timing separation threshold.
